(19) United States
(12) Patent Application Publication
(10) Pub. No.: US 2026/0187186 A1
(43) Pub. Date: Jul. 2, 2026

(54) ENABLING PARALLEL VARIABLE-RATE COMPRESSION AND DECOMPRESSION OF VALUES OF A TENSOR

(71) Applicant: Microsoft Technology Licensing, LLC, Redmond, WA (US)

(72) Inventor: Li ZHANG, Saratoga, CA (US)

(73) Assignee: Microsoft Technology Licensing, LLC, Redmond, WA (US)

(21) Appl. No.: 19/007,033

(22) Filed: Dec. 31, 2024

(51) Int. Cl. G06F 17/16

(52) U.S. Cl. CPC G06F 17/16

(57) ABSTRACT

For purposes of compression and decompression operations, a tensor is split into tiles having a tile size, and values at a given position in the respective tiles are processed as a stream. In some example implementations, for compression operations, a matrix processing tool can separately apply variable-rate compression to different streams of values of the tensor, with the different streams being associated with different positions of the tile size. For decompression operations, the matrix processing tool can quickly reconstruct different streams of values of the tensor. The decompression operations can be performed in parallel, with different decoders decompressing different streams of values of the tensor. In this way, soon after decompression starts, tensor blocks of values of the tensor can be loaded to local memory of tensor cores for matrix multiplication and accumulation operations, which can help reduce latency and fully utilize the tensor cores.

### BACKGROUND

Matrix multiplication operations are fundamental for deep learning, other types of machine learning, graphics, signal processing, simulation, modeling, and other applications. A typical matrix multiplication operation accepts two input matrices and produces an output matrix. The output matrix can also be an input to the operation, in which case the matrix product (of the two input matrices) is added to the values of the output matrix in an accumulation stage. In practice, matrix multiplication operations for neural networks and other machine learning applications can involve very large matrices having millions of elements. An input matrix can represent, for example, weights between nodes of two layers of a neural network, where each of the layers includes thousands or tens of thousands of nodes. Or, an input matrix can represent activations from nodes of a layer of the neural network, where the layer includes thousands or tens of thousands of nodes. Such an input matrix is an example of a tensor, which is represented as a two-dimensional array or other multi-dimensional array. More generally, a tensor, represented as a multi-dimensional array, can store values that model a relationship in an application such as deep learning, another type of machine learning, graphics, signal processing, simulation, or modeling.

Performing matrix multiplication operations for large tensors can consume incredible amounts of computing resources. Special-purpose computing hardware has been developed to perform matrix multiplication and accumulation operations more efficiently. For example, a tensor core is a hardware block dedicated to perform matrix multiplication and accumulation operations at higher speed and/or better precision, compared to other types of processing cores. A graphics processing unit (“GPU”) or neural processing unit (“NPU”) can include multiple tensor cores to perform matrix multiplication and accumulation operations quickly and efficiently. Even so, a tensor core or other processing core has limited memory to store input tensors and an output tensor for matrix multiplication and accumulation operations.

When an output tensor is large, the output tensor can be split into tensor blocks, which are assigned to different processing cores (e.g., tensor cores). At given core, a tensor block of the output tensor is loaded to fast, local memory accessible by the given core. At the given core, elements of the tensor block of the output tensor are computed from appropriate elements of the input tensors, which are loaded to the local memory accessible by the given core. When an input tensor is large, the input tensor can be split into tensor blocks, which are loaded to the fast, local memory accessible by the given core as needed for operations of the given core. Thus, if a large input tensor cannot be completely loaded into the local memory accessible by the given core, tensor blocks of the input tensor can be loaded for successive stages of operations, with intermediate results accumulated by the given core.

When the values of a tensor are not used as inputs to, or outputs from, a processing operation by a processing core (e.g., tensor core), the values of the tensor remain in system memory or storage. The values of the tensor can be compressed to reduce the amount of memory or storage used by the tensor. Previous approaches to compression and decompression of tensor values can result in time-consuming decompression operations, however. When values of a tensor need to be provided to processing cores (e.g., tensor cores) for matrix multiplication and accumulation operations, slow decompression operations can lead to delays in providing the values of the tensor to the processing cores. Such delays, in turn, can result in unused computing resources.

### SUMMARY

In summary, the detailed description presents innovations in compression and decompression of values of a tensor. For purposes of compression and decompression operations, a tensor is split into tiles having a tile size, and values at a given position in the respective tiles are processed as a stream. In some example implementations, for the compression operations, a matrix processing tool can separately apply variable-rate compression to different streams of values of the tensor, with the different streams being associated with different positions of the tile size. The compression operations, which reduce the amount of memory or storage used by the tensor, can be performed in parallel, with different encoders (implemented with different processing cores or different instances of encoder logic) compressing the different streams of values of the tensor. For the decompression operations, the matrix processing tool can quickly reconstruct different streams of values of the tensor. The decompression operations can be performed in parallel, with different decoders (implemented with different processing cores or different instances of decoder logic) decompressing different streams of values of the tensor. For example, the decoders can concurrently decode values at the respective positions of a first tile of the tensor, then concurrently decode values at the respective positions of a second tile of the tensor, and so on. A tensor block can include tensor values from one or more tiles. In this way, soon after decompression starts, the matrix processing tool can start to load tensor blocks of values of the tensor to local memory of tensor cores for matrix multiplication and accumulation operations, which can help reduce latency and fully utilize the tensor cores.

In particular, in some example hardware configurations, tensor cores accept tensor blocks of values from input tensors. Compression of the tensor values in sequential streams can improve compression efficiency. According to approaches described herein, the tensor values are arranged in streams such that, although each of the streams is decoded sequentially, the tensor values in a given tile can be decoded in parallel for their simultaneous availability to a given tensor core, which facilitates low-latency computation using the given tensor core.

According to a first set of techniques and tools described herein, a matrix processing tool compresses values of a tensor. The matrix processing tool receives the values of the tensor, which are logically organized along multiple dimensions (e.g., a width and height for the tensor). The tensor is split into multiple tiles that have a tile size with multiple positions. Each of the tiles includes a different subset of the values of the tensor. The matrix processing tool encodes a group of tiles among the multiple tiles as multiple streams. In particular, different positions among the positions of the tile size are associated with different streams among the multiple streams. For example, values at a first position in each tile of the group of tiles are in a first stream, values at a second position in each tile of the group of tiles are in a second stream, and so on. As part of encoding the group of tiles, for each given position, the matrix processing tool loads at least some of the values at the given position across the group of tiles in a given stream, encodes the loaded values at the given position across the group of tiles, and outputs the encoded data for the loaded values at the given position across the group of tiles. For the given position, an encoder can accept the values in the given stream as constant-rate input and produce the encoded data as variable-rate output. In this way, the matrix processing tool can exploit redundancy between values in the given stream to improve compression efficiency, while also enabling quick decompression of values of a given tile in parallel from separate streams.

According to a second set of techniques and tools described herein, a matrix processing tool decompresses values of a tensor. The matrix processing tool receives encoded data for the values of the tensor. The values of the tensor are logically organized along multiple dimensions (e.g., a width and height for the tensor). The tensor is split into multiple tiles having a tile size with multiple positions. Each of the tiles includes a different subset of the values of the tensor. The matrix processing tool decodes a group of tiles among the multiple tiles as multiple streams. In particular, different positions among the positions of the tile size are associated with different streams among the multiple streams. For example, values at a first position in each tile of the group of tiles have been encoded in a first stream, values at a second position in each tile of the group of tiles have been encoded in a second stream, and so on. As part of the decoding the group of tiles, for each given position, the matrix processing tool loads encoded data for at least some of the values at the given position across the group of tiles, decodes the encoded data for the values at the given position across the group of tiles, and outputs the values at the given position across the group of tiles in a given stream. For the given position, a decoder can accept the encoded data as variable-rate input and produce the values in the given stream as constant-rate output. In some example implementations, the matrix processing tool can quickly decode values of a given tile in parallel from separate streams. After decoding, a tensor block including tensor values from one or more tiles can be loaded to local memory of an available tensor core.

The innovations described herein can be implemented as part of a method, as part of a computer system (physical or virtual) configured to perform the method, or as part of a tangible computer-readable media storing computer-executable instructions for causing a processor system, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIGS. 1a and 1b are diagrams illustrating compression and decompression, respectively, of values at different positions of tiles of a tensor in separate streams.

FIG. 2 is a diagram illustrating an example architecture for a matrix processing tool configured to compress values at different positions of tiles of a tensor in separate streams.

FIG. 3 is a diagram illustrating an example architecture for a matrix processing tool configured to decompress values at different positions of tiles of a tensor in separate streams.

FIG. 4a is a flowchart illustrating a generalized technique for compression of values at different positions of tiles of a tensor in separate streams. FIG. 4b is a flowchart illustrating example parallel compression operations for the separate streams.

FIG. 5a is a flowchart illustrating a generalized technique for corresponding decompression of values at different positions of tiles of a tensor in separate streams. FIG. 5b is a flowchart illustrating example parallel decompression operations for the separate streams.

FIG. 6 is a diagram illustrating an example computer system in which some described embodiments can be implemented.

### DETAILED DESCRIPTION

The detailed description presents innovations in compression and decompression of values of a tensor. For purposes of compression and decompression operations, a tensor is split into tiles having a tile size, and values at a given position in the respective tiles are processed as a stream. For example, values at a first position in each tile of a group of tiles are processed in a first stream, values at a second position in each tile of the group of tiles are processed in a second stream, and so on, with the values at position n in each tile of the group of tiles being processed in an n^{th} stream. In some example implementations, for the compression operations, a matrix processing tool can separately apply variable-rate compression to different streams of values of the tensor, with the different streams being associated with different positions of the tile size. The compression operations reduce the amount of memory or storage used by the tensor. To reduce delay and increase utilization of computing resources, the compression operations can be performed in parallel, with different encoders (implemented with different processing cores or different instances of encoder logic) compressing the different streams of values of the tensor. For the decompression operations, the matrix processing tool can quickly reconstruct different streams of values of the tensor. To reduce delay and increase utilization of computing resources, the decompression operations can be performed in parallel, with different decoders (implemented with different processing cores or different instances of decoder logic) decompressing different streams of values of the tensor. For example, the decoders can concurrently decode values at the respective positions of a first tile of the tensor, then concurrently decode values at the respective positions of a second tile of the tensor, and so on. In this way, soon after decompression starts, the matrix processing tool can start to load tensor blocks that include tensor values from decoded tiles to local memory of tensor cores for matrix multiplication and accumulation operations, which can help avoid reduce latency and fully utilize the tensor cores.

### I. Introduction

Matrix multiplication operations are fundamental for deep learning, other types of machine learning, graphics, signal processing, simulation, modeling, and other applications. A typical matrix multiplication operation accepts two input matrices A and B and produces an output matrix C. The input matrix A has dimensions j×p, and the input matrix B has dimensions p×k. The output matrix C has dimensions j×k. The output matrix C can also be an input to the operation, in which case the matrix product A B is added to the matrix C in an accumulation stage. The matrix product A B can be scaled by a first scaling factor α, and the original matrix C can be scaled by a second scaling factor β. The overall operation for matrix multiplication and accumulation can be shown as C=α (A B)+β C.

In practice, matrix multiplication operations for neural networks and other machine learning applications can involve very large matrices having millions of elements. An input matrix can represent, for example, weights between nodes of two layers of a neural network, where each of the layers includes thousands or tens of thousands of nodes. A typical input matrix with values representing weights for a neural network can have a size of 4096×4096, 8192×8192, or more elements. Or, an input matrix can represent activations from nodes of a layer of the neural network, where the layer includes thousands or tens of thousands of nodes. An input matrix storing values for weights or activations is an example of a tensor, which is represented as a two-dimensional array or other multi-dimensional array. More generally, a tensor, represented as a multi-dimensional array, can store values that model a relationship in an application such as deep learning, another type of machine learning, graphics, signal processing, simulation, or modeling. In some examples, a tensor is represented as an array of values organized in two dimensions. The two dimensions can be termed width and height when describing the size of the tensor, or the two dimensions can be referred to as matrix sizes of an j×p matrix or p×k matrix. Alternatively, a tensor can be represented as an array of values organized in three, four, or more dimensions. Depending on implementation, the values of a tensor can be scalar values in an integer format (e.g., INT8, INT16), scalar values in a floating-point format (e.g., FP16, FP32, BFloat16, TF32), or values in another data format.

Tensor multiplication operations are extremely computationally intensive. Special-purpose computing hardware has been developed to perform matrix multiplication and accumulation operations efficiently. For example, a tensor core is a hardware block dedicated to perform matrix multiplication and accumulation operations at higher speed and/or better precision, compared to other types of processing cores. That is, a tensor core can be adapted to perform matrix multiplication and accumulation operations, can be reserved for such operations, or can simply prioritize performance of such operations. A GPU or NPU can include multiple tensor cores. Even so, a tensor core or other processing core has limited memory to store input tensors and an output tensor for matrix multiplication and accumulation operations. In particular, providing values of input tensors to tensor cores in a timely manner is an important aspect of overall performance. A bottleneck in loading of value of input tensors can result in unused computational power of tensor cores.

When an output tensor is large, the output tensor can be split into tensor blocks, which are assigned to different processing cores (e.g., tensor cores). For example, a large output tensor can be split into 16 tensor blocks, which are assigned to 16 different processing cores. More generally, an output tensor can be split into s tensor blocks, which are assigned to v available processing cores, where all tensor blocks can be concurrently assigned to available processing cores if s≤v, but processing operations for some tensor blocks are deferred if s>v. At a given core, a tensor block of the output tensor is loaded to fast, local memory accessible by the given core. At the given core, elements of the tensor block of the output tensor are computed from appropriate elements of input tensors, which are loaded to the local memory accessible by the given core.

Similarly, when an input tensor is large, the input tensor can be split into tensor blocks, which are loaded to the fast, local memory accessible by the given core as needed for operations of the given core. For example, a large input tensor can be split into 64, 128, 256, or more tensor blocks, which are loaded to local memory of a tensor core or tensor cores as needed for operations of the core(s). A “tensor block” is a block of values of an input tensor that is provided to a processing core (e.g., tensor core). If a large input tensor cannot be completely loaded into the local memory accessible by a given core, tensor blocks of the input tensor can be loaded for successive stages of operations, with intermediate results accumulated by the given core.

In some example implementations, a matrix processing tool uses a tensor block blocking algorithm to determine a size of tensor blocks of an input tensor. The tensor block blocking algorithm can determine the tensor block size based on hardware characteristics of processing cores (e.g., tensor cores), the size of an input tensor, the data format of values of the input tensor, and/or other factors. Some types of tensor cores are most effective when performing multiplication operations for values of input tensors whose dimensions are a particular multiple (e.g., a multiple of 4, 8, or 16 elements per dimension of an input tensor, depending on the data format of the values of the input tensor). For example, the tensor block size is 16×16, 32×16, 16×32, 32×32, 64×32, etc. for a tensor core that works most effectively when performing multiplication operations for values in an input matrix whose dimensions are a multiple of 16. For a given configuration of processing cores having specific hardware characteristics, the matrix processing tool can select a tensor block size depending on the size of the input tensor and data format of values.

The matrix processing tool can also try to set the tensor block size so that the input tensor is evenly divisible by the tensor block size. In this way, the input tensor can be evenly split into an integer number of tensor blocks, without any tensor block including elements “outside” the input tensor. (Although matrix multiplication and accumulation operations can account for non-values of a tensor block that are outside the input tensor, processing capacity of the cores is wasted.) The number of available processing cores (e.g., tensor cores) can also affect the decision about tensor block size. Having a larger tensor block size can reduce bandwidth utilization from loading operations but may result in underutilization of available processing cores. On the other hand, having a smaller tensor block size can improve utilization of available processing cores by having more tensor blocks available to load to waiting processing cores but can result in worse bandwidth utilization. Moreover, having the number of tensor blocks be an integer multiple of the number of available processing cores can help utilization of the processing cores.

### II. Enabling Parallel Compression and Decompression of Tensor Values

When the values of a tensor are not used as inputs to, or outputs from, a matrix processing operation by a processing core (e.g., tensor core), the values of the tensor remain in system memory or storage. The values of the tensor can be compressed to reduce the amount of memory or storage used by the tensor. For example, suppose an 8192×4096 tensor stores 16-bit floating-point values. Each floating-point value uses two bytes. In uncompressed form, the tensor uses 8192×4096×2=67,108,864 bytes of memory or storage. By compressing the tensor, the amount of memory or storage used can be dramatically reduced, which can in turn enable larger tensors to be used for an application. Recently, compression has helped to improve the effectiveness of large language models (“LLMs”) and other types of machine learning models.

Previous approaches to compression and decompression can result in time-consuming decompression operations. When a matrix processing tool provides values of a tensor to tensor cores for matrix multiplication and accumulation operations, slow decompression operations can lead to delays in providing the values of the tensor to the tensor cores. Such delays, in turn, can result in unused computing resources. In particular, while many types of variable-rate compression are effective for data compression, applying variable-rate compression to values of tensors presents challenges in terms of timing. Often, compression efficiency depends on processing of values serially for both compression and decompression operations. With a simple implementation of compression and decompression operations, values of a two-dimensional tensor are processed sequentially in a first row, then a second row, then a third row, and so on, according to a raster scan pattern. With such an approach, the first row of values of a row of tensor blocks is decoded, then the second row of values of the row of tensor blocks is decoded, and so on, until the values of a first tensor block are decoded and available for loading to local memory of a tensor core for matrix multiplication and accumulation operations. This can add significant delay between the start of decompression and the loading of the values of the first tensor block, which can create a bottleneck for downstream computation. For example, for suppose an 8192×4096 tensor is split into 16×16 tensor blocks. The tensor includes 512 rows of tensor blocks and 256 columns of tensor blocks. With a raster scan by row of values of the tensor, the first 15 rows of tensor values and first 16 values of the first tensor block must be decoded before the values of the first tensor block can be loaded to local memory of a tensor core.

Alternatively, values of a two-dimensional tensor could be processed sequentially on a block-by-block basis according to a raster scan pattern or zig-zag pattern within a tensor block. With such an approach, the values of a first tensor block are decoded, then the values of a second tensor block are decoded, and so on. Upon decoding, the values of a tensor block are available for loading to local memory of a tensor core for matrix multiplication and accumulation operations. There is still delay between the start of decompression and the loading of the values of the first tensor block, however, which can result in a bottleneck for downstream computation. Also, available computing resources (e.g., processing cores) for compression and decompression might not be used efficiently.

In contrast, according to approaches described herein, for a tensor split into tiles, a matrix processing tool processes values of the tiles for compression and decompression operations in a direction “orthogonal” to the dimensions of the tiles. Aside from enabling compression operations to be performed by different encoders (implemented, e.g., with different processing cores or different instances of encoding logic) in parallel for the different positions of a tile, decompression operations can be performed by different decoders (implemented, e.g., with different processing cores or different decoding logic) in parallel for the different positions of a tile, which enables low latency loading of values of tensor blocks after the start of decompression. A tensor block can be the same size as the tiles used for compression and decompression. In this case, a tensor block can include decoded tensor values from a single tile. Or, a tensor block can be a different size than the tiles (e.g., including decoded tensor values from part of a tile or from multiple tiles).

For example, suppose a tensor T has dimensions [W, H]. The tile size for tiles is [w, h], where w<W and h<H. Assuming even division along the dimensions Wand H, the tensor T is reshaped into (W×H)/(w×h) tiles, where each of the tiles is a w×h block. The reshaped tensor T can be organized as tiles for purposes of a working representation of the tensor Tin system memory as well as compression and decompression operations. Alternatively, the organization of the reshaped tensor T can be a logical organization tracked for purposes of compression and decompression operations, without changing the working representation of the tensor Tin system memory. In any case, compression operations and decompression operations happen along the direction of tiles for the respective positions of the tile size. The matrix processing tool can compress the values of the tensor Tinto w×h streams of encoded data, each of the streams representing a sequence of values in a given position across the tiles of the tensor T. For example, for a tensor T split into 8×8 tiles, the values of the tensor T are encoded as 64 streams of encoded data—stream 1 for values at position 1 of the tiles, stream 2 for values at position 2 of the tiles, and so on, up to stream 64 for values at position 64 of the tiles. From the w×h streams of encoded data, the matrix processing tool can decompress the values of the tensor T as sequences of values at the respective positions, on a tile-by-tile basis.

If the tensor T is not evenly divided into w×h tiles along the dimensions W and H, additional tiles include some values of the tensor T along with zero values for padding. In other words, if the tensor T has a number of values that is not an integer multiple of the tile size in any dimension, the tensor T can, in effect, be padded with zero values out to an integer multiple of the tile size in that dimension. (The tensor T, or one or more of the tiles, can be padded with zero values so that the tensor T includes an integer count of tiles in each dimension, and such added zero values can be removed after decompression.) A matrix processing tool can account for the zero values added for padding, e.g., ignoring the padded zero values in compression and decompression operations based on tile size and size of the tensor; or including the padded zero values in compression and decompression operations, but tracking the padded locations so that invalid accesses are not performed using values at the padded locations.

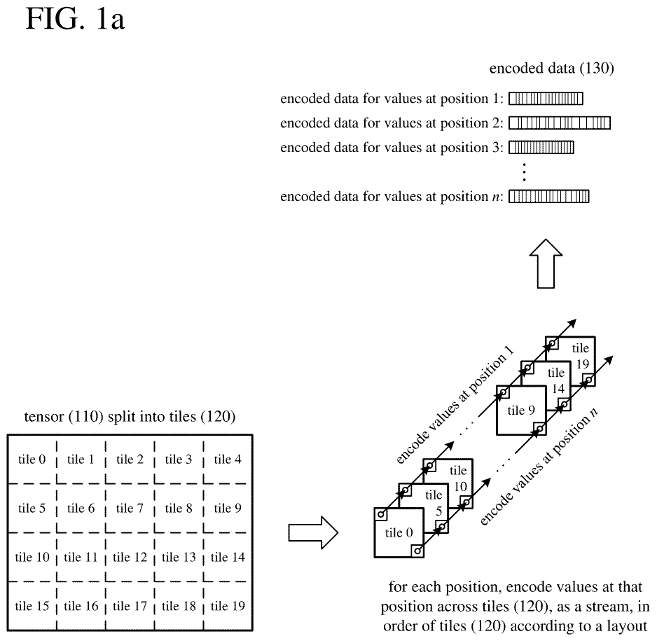

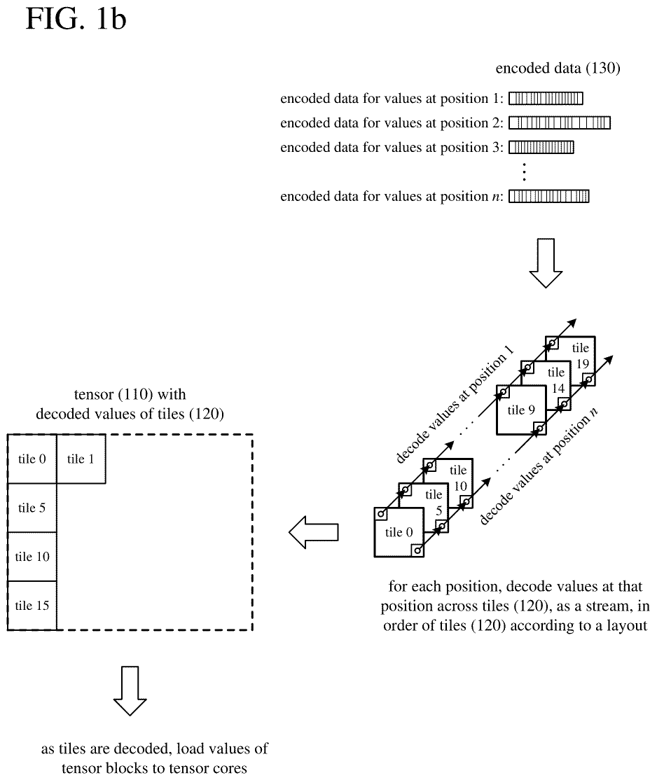

FIGS. 1a and 1b show an example of compression and decompression, respectively, of values at different positions of tiles (120) of a tensor (110) in separate streams. The example in FIGS. 1a and 1b is simplified in terms of the sizes of the tensor (110) and tiles (120). The tiles are relatively small (4×4 tiles). In practice, a tensor typically is split into hundreds or thousands of tiles, and the tiles are larger (e.g., 8×8, 16×8, 8×16, or 16×16).

In FIG. 1a, the tensor (110) is evenly split into 20 tiles (120), which are labeled tile 0 to tile 19. The values of the tiles (120) are encoded, producing encoded data (130). In particular, for a given position of the tiles (120), values at that position across the tiles (120) are encoded as a stream. For example, the values at position 1 of the tiles are encoded as a stream for position 1, producing encoded data for the values at position 1. Similarly, the values at position 2 of the tiles are encoded as a stream for position 2, producing encoded data for the values at position 2, and so on. The encoding operations can be performed in parallel for different positions/streams of values.

For compression and decompression operations, the tiles are ordered according to a layout for the multiple tiles. That is, in addition to indicating the tile size and locations of the tiles (120) within the tensor (110), the layout indicates the ordering of tiles for compression and decompression operations. In FIG. 1a, the ordering is vertical for a column of tiles. Values at a given position across the tiles are encoded for tile 0, then tile 5, then tile 10, then tile 15, and so on. In the next column of tiles, the ordering can be top-to-bottom or bottom-to-top. This proceeds through the final column of tiles, for which values at the position are encoded for tiles 4, 9, 14, and 19. Alternatively, the ordering of tiles can be horizontal for rows of tiles or follow an arbitrary pattern through the tiles. In general, the ordering can be set according to a pattern of expected utilization of values of tensor blocks overlapping the tiles. For example, if tensor blocks overlapping the tiles (120) are expected to be used by tensor cores as the matrix processing tool horizontally traverses the tensor (110), the tiles (120) can be ordered along tile rows for compression and decompression, so that the tensor blocks overlapping the tiles (120) can be loaded more quickly as the tiles are decoded. On the other hand, if tensor blocks overlapping the tiles (120) are expected to be used by tensor cores as the matrix processing tool vertically traverses the tensor (110), the tiles (120) can be ordered along tile columns for compression and decompression, so that the tensor blocks overlapping the tiles (120) can be loaded more quickly as the tiles are decoded. (As noted above, the tile size can be the same as the size of tensor blocks, in which case a tensor block can include tensor values from a single tile. Alternatively, the tile size can be different than the size of tensor blocks, e.g., so that a tensor block includes tensor values from multiple tiles.)

The layout of tiles in a tensor, including the order of tiles for purposes of compression and decompression, can be directly indicated by metadata. Such metadata can be included with encoded data for the tensor. Alternatively, the layout of tiles in a tensor, including the order of tiles for purposes of compression and decompression, can be derived according to one or more rules (e.g., tiles of a defined tile size for a configuration of tensor cores and size of an input tensor, with the order of tiles following an inner dimension p that is common between two input tensors j×p and p×k so that tensor blocks overlapping the tiles can be quickly loaded upon decoding). In this case, the layout of tiles need not be indicated by metadata but can instead be derived, as needed, from other information.

In FIG. 1b, the encoded data (130) for the tensor (110) is decoded to reconstruct the values of the tiles (120). In particular, for a given position of the tiles (120), values at that position across the tiles (120) are decoded as a stream. For example, the encoded data for values at position 1 of the tiles (120) is decoded, producing the values at position 1 as a stream. Similarly, the encoded data for values at position 2 of the tiles (120) is decoded, producing the values at position 2 as a stream, and so on. The decoding operations can be performed in parallel for different positions/streams of values.

For some types of compression and decompression, values are processed in the same order for compression or decompression, as shown in FIGS. 1a and 1b. Alternatively, depending on the type of compression and decompression, values can be processed in a reverse order for compression, compared to decompression.

The type of compression and decompression depends on implementation. In general, the compression can include lossy compression operations and/or lossless compression operations, and the decompression includes corresponding decompression operations. Thus, a matrix processing tool can perform a combination of lossy compression and lossless compression, then corresponding decompression. Alternatively, a matrix processing tool can perform only lossless compression and corresponding decompression. Or, a matrix processing tool can perform only lossy compression and corresponding decompression.

Lossy compression can include quantization, scaling, or other types of operations that result in loss of quality. Depending on implementation, lossy compression may produce fixed-rate encoded data or variable-rate encoded data (often in combination with lossless compression after the lossy compression). Fixed-rate approaches tend to be faster than variable-rate approaches but have worse compression ratio. Decompression operations such as inverse quantization, inverse scaling, or other operations restore values to an original data format, but typically some quality (fidelity to the original values) has been lost.

Lossless compression can include any of various types of entropy coding, such as context-adaptive binary arithmetic coding, another variant of arithmetic coding, range coding, Huffman coding, another variant of variable length coding, asymmetric numeral system coding, Lempel Ziv Welch encoding, and another variant of Lempel Ziv encoding. Lossless compression typically produces variable-rate encoded data, depending on the entropy of the values of the tensor being compressed. Compression efficiency can vary for different types of entropy coding, with some types of entropy coding providing better compression efficiency (lower data rate) but taking more time, and with other types of entropy coding providing worse compression efficiency (higher data rate) but taking less time. Thus, selection of a type of entropy coding can involve a tradeoff between speed of encoding and compression efficiency. Decompression operations can include any of various types of entropy decoding, which in general reverse the entropy coding that has been applied.

Different types of entropy coding can be selected for different types of values of a tensor, to trade off speed of encoding and compression efficiency. In general, compression operations can be slower for static values (such as weights between nodes of a trained neural network during inference activity), since the values will not change and are not re-compressed during inference activity. (In this case, previously compressed encoded data can be reused as needed for the static values.) Decompression operations for static values should still be fast, however, so as to enable fast loading of tensor values to local memory of tensor cores. On the other hand, compression operations should be faster for dynamic values (such as activations from nodes of a trained neural network during inference activity), since the values are expected to change and may be re-compressed when in system memory. Thus, compression operations for dynamic values should be fast, so as to enable re-compression of values to reduce the amount of memory or storage used by the tensor, and decompression operations for dynamic values should also be fast, so as to enable fast loading of values to local memory of tensor cores.

Compression operations are applied to encode values in a stream for a position across tiles, and decompression operations are applied to reconstruct the values in the stream for the position across tiles. Compression operations can be performed in parallel for different positions/streams of values to reduce encoding time and utilize available computing resources (e.g., processing cores). In other words, values at different positions of a tile can be compressed concurrently, with the values in a given stream (for a given position) being compressed independently of values in other streams (for other positions). Decompression operations can be performed in parallel for different positions/streams of values to reduce decoding time (and thereby provide tensor blocks with decoded values of tiles to load to local memory of tensor cores more quickly) and utilize available computing resources (e.g., processing cores). In other words, values at different positions of a tile can be decompressed concurrently, with the values in a given stream (for a given position) being decompressed independently of values in other streams (for other positions). In this way, in some example implementations, values at different positions of a tile can be decoded in parallel, to enable faster loading of a tensor block that includes the tile to local memory of a tensor core. For variable-rate encoding, a matrix processing tool can use an output buffer for encoding and input buffer for decoding that are large enough to account for different compression ratios across streams. In this way, the matrix processing tool can provide variable-rate compression with high compression ratios for values of a tensor by exploiting redundancy between values within each stream, while also enabling decompression with low latency at the tensor block level for effective utilization of tensor cores. That is, decompression quickly starts to provide decoded values for tiles in tensor blocks that can be loaded to local memory of tensor cores. In some example implementations, decoded values of tiles can be provided at a constant rate or nearly constant rate even from variable-rate encoded data for the tiles.

In some examples, all tiles of a tensor are compressed or decompressed as a single group. Compression operations or decompression operations for each stream start at a given position of a first tile of the tensor and traverse (for the given position) all tiles of the tensor according to the order indicated by the layout, finishing at the given position of a final tile of the tensor. Alternatively, the tiles of tensor can be compressed or decompressed as multiple groups. In this case, compression operations or decompression operations for each stream start at a given position of a first tile of a tile group and traverse (for the given position) all tiles of the tile group according to the order indicated by the layout, finishing at the given position of a final tile of the tile group. For a different tile group, compression operations or decompression operations for each stream start at a given position of a first tile of the different tile group and traverse (for the given position) all tiles of the different tile group according to the order indicated by the layout, finishing at the given position of a final tile of the different tile group. The first tiles of the different tile groups provide “random-access points” at which compression or decompression operations can begin. For example, for a large tensor, the tiles could be divided into 8 tile groups, with each tile group being compressed and decompressed independently of other tile groups. Each of the 8 tile groups has a first tile that provides a random-access point at which compression or decompression begins for the tile group. Using tile groups with random-access points can hurt compression efficiency due to loss of context from previously coded values upon a restart. On the other hand, using tile groups with random-access points can make access to selected tiles faster. For example, consider the delay involved to decode values of a final tile of a tensor with tiles organized as a single group. If the tiles of the tensor are split into 8 tile groups, decoding the final tile happens much faster.

Innovations described herein can provide several technical benefits, depending on implementation.

Compression of values of a tensor can reduce the amount of memory or storage used by the tensor, compared to an uncompressed version. This can reduce costs for memory or storage in addition to freeing space for other data. In particular, variable-rate compression can provide more aggressive reduction than fixed-rate compression. Also, adapting the type of compression used depending on the type of data (e.g., for static values versus dynamic values) can provide for greater reduction (through improved compression efficiency) where doing so is consistent with operating parameters.

Parallel compression or decompression of the values of a tensor in different streams, for different positions of a tile size, can increase the speed of compression operations or decompression operations. In particular, parallel decompression operations can enable faster decoding of the values of a tensor. The parallel compression or decompression operations can provide more efficient utilization of hardware resources (e.g., processing cores) available for the compression or decompression operations. In addition, faster decompression operations can make values of a tensor available for loading to local memory of tensor cores more quickly, leading to more efficient utilization of the tensor cores. More efficient utilization of processing cores or tensor cores can lead to reduction in energy consumption.

Approaches described herein can be utilized when processing values of tensors for large language models, other deep learning models, or other types of machine learning models. In particular, approaches described herein can be used to compress and decompress values of input tensors that have width and/or height of 4096, 8192, or more elements. Decompression operations can be performed during inference activity on static values such as weights of edges between nodes of layers of a neural network. Both compression and decompression operations can be performed during inference activity on dynamic values such as activations from nodes of layers of a neural network. With the compression and decompression operations, larger input tensors (and larger models) can effectively be supported using the available hardware resources, which enables use of more effective models. Aside from uses in machine learning applications, approaches described herein can be used for graphics, signal processing, simulation, modeling, and other applications.

### II. Example Architectures for Compression and Decompression of Values at Different Positions of Tiles of a Tensor in Separate Streams

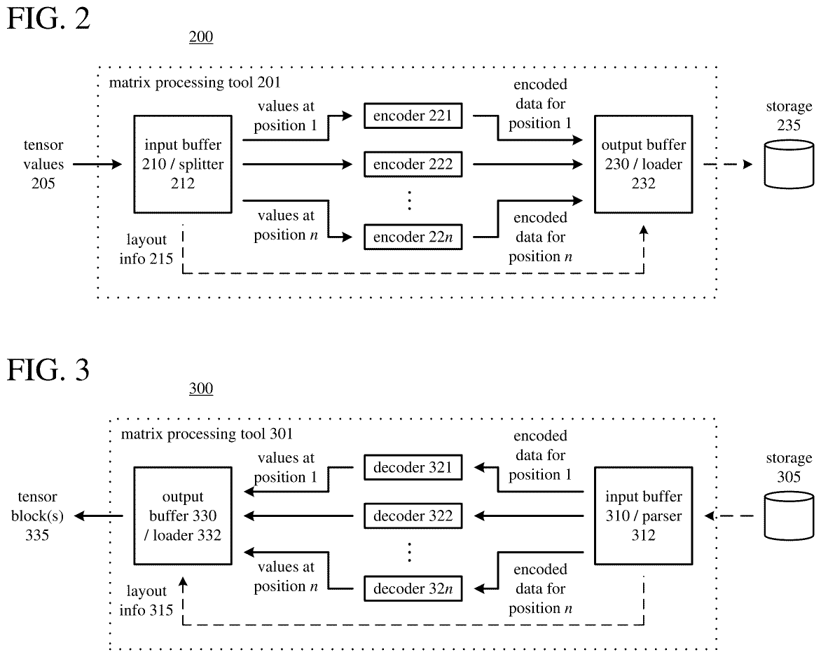

FIG. 2 shows an example architecture (200) for a matrix processing tool (201) configured to compress values at different positions of tiles of a tensor in separate streams. The matrix processing tool (201) includes an input buffer (210), splitter (212), multiple encoders (221, 222, . . . 22n) for streams of values, an output buffer (230), and a loader (232). Depending on implementation, modules of the matrix processing tool (201) can be combined or separated. In general, the matrix processing tool (201) is configured to accept, as input, values (205) of a tensor and produce, as output, encoded data for the tensor, which may be stored in storage (235) or kept in system memory.

The matrix processing tool (201) is implemented in a computer system, which includes processing cores, tensor cores, various types of memory, and storage (235). The processing cores used for compression operations are hardware blocks of a central processing unit (“CPU”). Alternatively, the processing cores used for compression operations can be implemented as part of a GPU or NPU. The various types of memory can include system memory (e.g., random access memory), one or more levels of caches, local memory for cores, and registers. In general, a tensor core or processing core has a relatively small amount of local memory accessible to it for fast transfer operations. Aside from this local memory, one or more caches may store data as an intermediary between local memory of the cores and slower (but much larger) system memory.

The values (205) of the tensor are stored in system memory. The input buffer (210) is configured to receive and store values (205) of the tensor. The input buffer (210) is implemented using memory of the computer system, e.g., a cache, system memory. The splitter (212) is configured to reshape the values (205) of the tensor into multiple tiles. In doing so, the splitter (212) can impose an intermediate representation on the values (205), e.g., so that individual tiles are in a logical three-dimensional arrangement for a two-dimensional tensor. Alternatively, the splitter (212) can track boundaries of the multiple tiles within the tensor for purposes of encoding and decoding operations, without changing the intermediate representation of the values (205) of the tensor.

The splitter (212) is configured to produce layout information (215) that indicates tile size as well as order of the tiles for purposes of compression and decompression. Alternatively, if tile size can be derived from other information (e.g., size of the tensor), tile size information need not be indicated in layout information (215). Also, if the order of tiles for purposes of compression and decompression can be derived from other information or is predefined, order information need not be indicated in layout information (215).

From the input buffer (210), the matrix processing tool (201) loads streams of values for different positions of a tile size to the encoders (221, 222, . . . , 22n). For example, as shown in FIG. 2, the matrix processing tool (201) loads a stream of values at position 1 to a first encoder (221), loads a stream of values at position 2 to a second encoder (222), and loads a stream of values at position n to an n^{th} encoder (22n). Within a stream, values are ordered in a sequence according to the ordering of tiles indicated in the layout information (215). In general, in the example architecture (200), the count of encoders (221, 222, . . . , 22n) is equal to the count of positions of the tile size. The count of processing cores used for the encoders (221, 222, . . . , 22n) depends on implementation. If the count of processing cores used for the encoders (221, 222, . . . , 22n) is equal to the count of positions of the tile size, the respective streams of values can be encoded in parallel by the encoders (221, 222, . . . , 22n). Alternatively, if the count of processing cores used for the encoders (221, 222, . . . , 22n) is less than the count of positions of the tile size, one or more of the encoders (221, 222, . . . , 22n) can be implemented by the same processing core at different times (for encoding that is serial, not in parallel).

Each of the encoders (221, 222, . . . , 22n) is configured to receive a stream of tensor values at a given position and encode the values, producing encoded data for the stream of tensor values at the given position. The encoders (221, 222, . . . , 22n) can be configured to perform lossy compression, e.g., quantization or scaling. The encoders (221, 222, . . . , 22n) can also be configured to perform lossless compression using a form of entropy coding, e.g., context-adaptive binary arithmetic coding, another variant of arithmetic coding, range coding, Huffman coding, another variant of variable length coding, asymmetric numeral system coding, Lempel Ziv Welch encoding, or another variant of Lempel Ziv encoding. The type of compression used depends on implementation and can be selected to trade off compression efficiency and encoding speed.

The encoders (221, 222, . . . , 22n) are configured to output encoded data for the respective streams to the output buffer (230). For example, as shown in FIG. 2, the first encoder (221) outputs encoded data for the stream of values at position 1, the second encoder (222) outputs encoded data for the stream of values at position 2, and the n^{th} encoder (22n) outputs encoded data for the stream of values at position n. The output buffer (230) is configured to receive and store the encoded data for the tensor. The output buffer (230) is implemented using memory of the computer system, e.g., a cache, system memory. The output buffer (230) is also configured to receive and store, in association with the encoded data for the tensor, the layout information (215) to the extent the layout information (215) is provided (and is not instead derived as needed). The loader (232) is configured to swap, as needed, encoded data from system memory to storage (235).

FIG. 3 shows an example architecture (300) for a matrix processing tool (301) configured to decompress values at different positions of tiles of a tensor in separate streams. The matrix processing tool (301) includes an input buffer (310), parser (312), multiple decoders (321, 322, . . . 32n) for streams of values, an output buffer (330), and a loader (332). Depending on implementation, modules of the matrix processing tool (301) can be combined or separated. In general, the matrix processing tool (301) is configured to accept, as input, encoded data for the tensor, which may be retrieved from storage (305) or kept in memory, and to produce, as output, values of the tensor in tiles, which may be included in one or more tensor blocks (335) loaded to local memory of one or more tensor cores. A tensor core can have its own local memory or share its local memory with one or more other tensor cores.

The matrix processing tool (301) is implemented in a computer system, which includes processing cores, tensor cores, various types of memory, and storage (305). The processing cores used for decompression operations are hardware blocks of a CPU. Alternatively, the processing cores used for decompression operations can be implemented as part of a GPU or NPU. Compared to other processing cores, the tensor cores are hardware blocks dedicated to perform matrix multiplication and accumulation operations at higher speed and/or better precision, and are typically implemented as part of a GPU or NPU. The various types of memory can include system memory (e.g., random access memory), one or more levels of caches, local memory for cores, and registers. In general, a tensor core or processing core has a relatively small amount of local memory accessible to it for fast transfer operations. Aside from this local memory, one or more caches may store data as an intermediary between local memory of the cores and slower (but much larger) system memory.

The parser (312) is configured to swap, as needed, encoded data to system memory from storage (305) and to parse encoded data for different streams. The input buffer (310) is configured to receive, from storage as needed, and store encoded data for the tensor. The input buffer (310) is implemented using memory of the computer system, e.g., a cache, system memory. The input buffer (310) is also configured to receive and store, in association with the encoded data for the tensor, the layout information (315) to the extent the layout information (315) has been provided (and is not instead derived as needed).

From the input buffer (310), the matrix processing tool (301) loads encoded data for streams of values for different positions of a tile size to the decoders (321, 322, . . . , 32n). For example, as shown in FIG. 3, the matrix processing tool (301) loads encoded data for a stream of values at position 1 to a first decoder (321), loads encoded data for a stream of values at position 2 to a second decoder (322), and loads encoded data for a stream of values at position n to an n^{th} decoder (32n). In general, in the example architecture (300), the count of decoders (321, 322, . . . , 32n) is equal to the count of positions of the tile size. The count of processing cores used for the decoders (321, 322, . . . , 32n) depends on implementation. If the count of processing cores used for the decoders (321, 322, . . . , 32n) is equal to the count of positions of the tile size, the respective streams of values can be decoded in parallel by the decoders (321, 322, . . . , 32n). Alternatively, if the count of processing cores used for the decoders (321, 322, . . . , 32n) is less than the count of positions of the tile size, one or more of the decoders (321, 322, . . . , 32n) can be implemented by the same processing core at different times (for decoding that is serial, not in parallel).

Each of the decoders (321, 322, . . . , 32n) is configured to receive encoded data for a stream of tensor values at a given position and decode the values, producing the stream of tensor values at the given position. Within a stream, values are ordered in a sequence according to the ordering indicated in the layout information (315). The decoders (321, 322, . . . , 32n) can be configured to perform lossy decompression, e.g., inverse quantization or inverse scaling. The decoders (321, 322, . . . , 32n) can also be configured to perform lossless decompression using a form of entropy decoding, e.g., to reverse context-adaptive binary arithmetic coding, another variant of arithmetic coding, range coding, Huffman coding, another variant of variable length coding, asymmetric numeral system coding, Lempel Ziv Welch encoding, or another variant of Lempel Ziv encoding. The type of decompression used depends on implementation and, in general, reverses corresponding compression.

The decoders (321, 322, . . . , 32n) are configured to output tensor values for the respective streams to the output buffer (330). For example, as shown in FIG. 3, the first decoder (321) outputs a stream of values at position 1, the second decoder (322) outputs a stream of values at position 2, and the n^{th} decoder (32n) outputs a stream of values at position n. The output buffer (330) is configured to receive and store values of the tensor. The output buffer (330) is implemented using memory of the computer system, e.g., a cache, system memory.

The loader (332) is configured to load one or more tensor blocks (335) of tensor values to local memory of tensor cores, as needed. The tensor block(s) (335) include decoded tensor values of tile(s) in the output buffer (330). The size of the tensor block(s) (335) can be the same as the tile size, in which case a tensor block can include a single tile. Alternatively, the size of the tensor block(s) (335) can be different than the tile size, in which case a tensor block can include part of a tile or values from multiple tiles. In loading tensor block(s) (335), the loader (332) can follow an intermediate representation of the tensor values, e.g., for individual tiles in a logical three-dimensional arrangement for a two-dimensional tensor. Alternatively, the loader (332) can track boundaries of the multiple tiles within the tensor for purposes of encoding and decoding operations, with no change to the intermediate representation of the tensor values. The loader (332) is configured to use layout information (315) that indicates tile size as well as order of the tiles for purposes of compression and decompression. Alternatively, if tile size can be derived by the loader (332) from other information (e.g., size of the tensor), tile size information need not be indicated in layout information (315). Also, if the order of tiles for purposes of compression and decompression can be derived from other information or is predefined, order information need not be indicated in layout information (315).

Although FIGS. 2 and 3 shows separate matrix processing tools (200, 300), in practice a single matrix processing tool can implement both the matrix processing tool (201) of FIG. 2 and matrix processing tool (301) of FIG. 3. In this case, the input buffer (210) of FIG. 2 and output buffer (330) of FIG. 3 can be the same buffer. Similarly, the output buffer (230) of FIG. 2 and input buffer (310) of FIG. 3 can be the same buffer, and the storage (235) and storage (305) can be the same storage. An encoder (221, 222, . . . 22n) and corresponding decoder (321, 322, . . . 32n) can be implemented with the same module or different modules. In operation, for some types of values (e.g., dynamic values for activations), encoded data can be decompressed and changed values can be re-compressed as needed. For other types of values (e.g., static values for weights), encoded data can be decompressed as needed, with the values discarded (instead of re-compressed) if there are no changes to the values.

### IV. Example Techniques for Compression and Decompression of Values at Different Positions of Tiles of a Tensor in Separate Streams

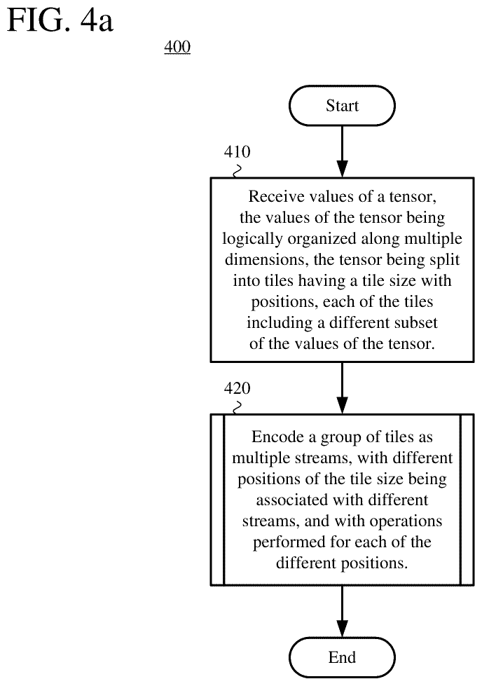

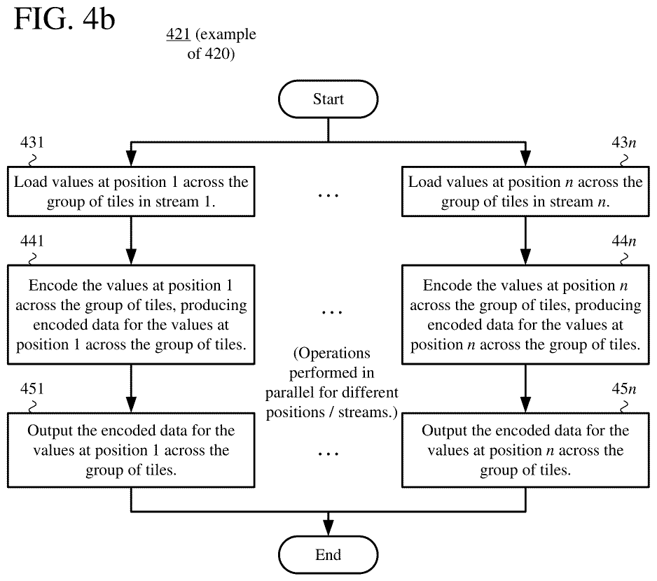

FIG. 4a shows a generalized technique (400) for compression of values at different positions of tiles of a tensor in separate streams. FIG. 4b shows example parallel compression operations (421) for the separate streams. The generalized compression technique (400) can be performed by a matrix processing tool (201) as described with reference to FIG. 2 or other matrix processing tool.

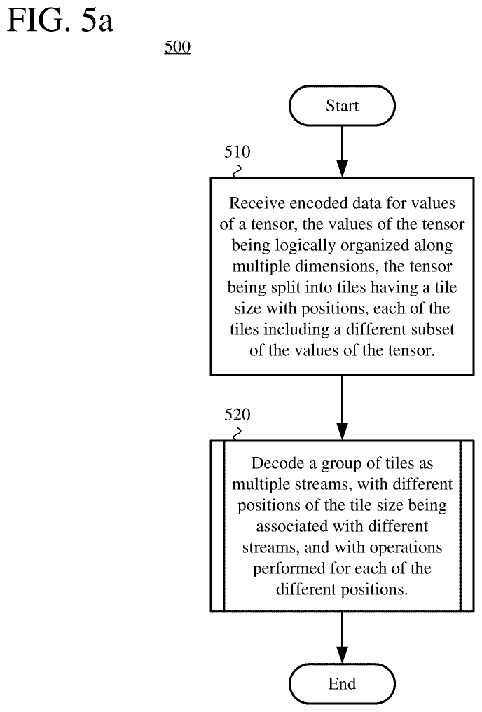

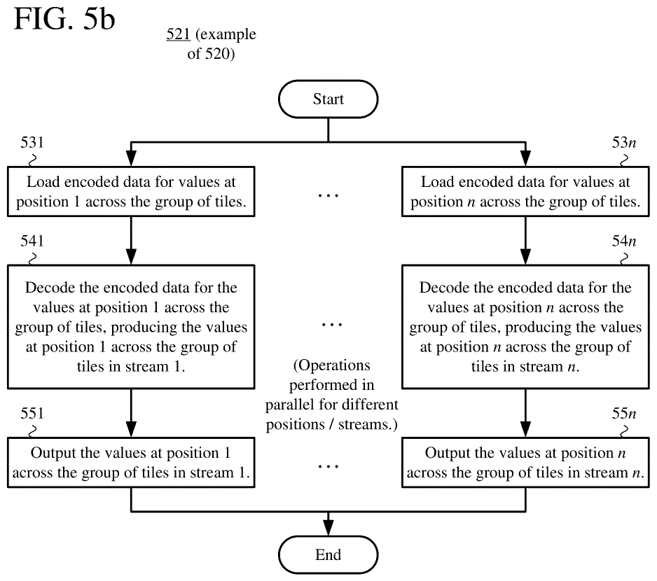

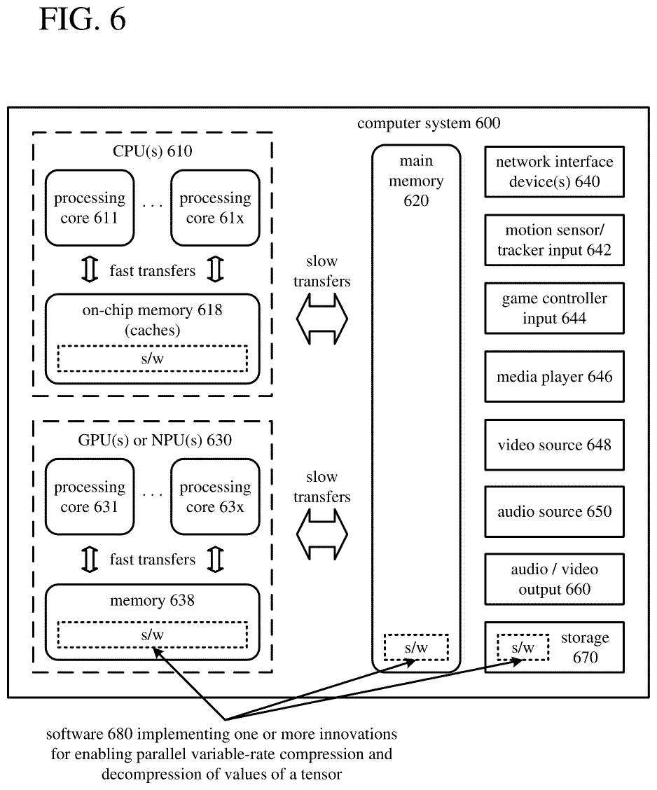

FIG. 5a shows a generalized technique (500) for corresponding decompression of values at different positions of tiles of a tensor in separate streams. FIG. 5b shows example parallel decompression operations (521) for the separate streams. The generalized decompression technique (500) can be performed by a matrix processing tool (301) as described with reference to FIG. 3 or other matrix processing tool.

The values of the tensor can be weights of edges between nodes of two layers of a neural network, bias values for nodes of a layer of a neural network, or results from activation functions at nodes (that is, activations from the nodes) of a layer of a neural network. Alternatively, the values of the tensor can be values for another type of tensor. Depending on implementation, the values of the tensor can be floating point values (each including a mantissa value and an exponent value) having 8 bits, 16 bits, or 32 bits, integer values having 8 bits or 16 bits, or values in another format.

In any case, the values of the tensor are logically organized along multiple dimensions. The tensor is split, at least for purposes of compression and decompression, into multiple tiles having a tile size with multiple positions. In some examples, the size of the tensor is [W, H], with W being the width of the tensor, and H being the height of the tensor. The size of the tiles is [w, h], with w being the width of each of the multiple tiles, and h being the height of each of the multiple tiles, and where w is less than W, and h is less than H. More generally, the values of the tensor are logically organized along i dimensions, and, for each of the multiple tiles, a subset of the values of the tensor in that tile are logically organized along the i dimensions, where i is 2, 3, or 4. The size of the tensor depends on implementation. For some applications (e.g., training operations or inference operations for a machine learning model), the tensor can have a size in each dimension of over 1,000 or over 10,000 values (elements). For other applications, the tensor can have a smaller size but still be over 100 values (elements) in each dimension. The tile size can depend on the hardware characteristics of processing cores on a computer system (e.g., count of available processing cores). Tile sizes that are a multiple of 4, 8, or 16 in each dimension are common.

With reference to FIG. 4a, a matrix processing tool receives (410) values of a tensor. The values of the tensor are logically organized along multiple dimensions. The tensor is split into multiple tiles having a tile size with multiple positions, where each of the tiles includes a different subset of the values of the tensor.

The matrix processing tool encodes (420) a group of tiles (among the multiple tiles of the tensor) as multiple streams. Different positions (among the multiple positions) of the tile size are associated with different streams (among the multiple streams for the group of tiles of the tensor). As part of the encoding (420) the group of tiles, the matrix processing tool performs operations for each of the different positions of the tile size. For example, for each given position, the matrix processing tool loads at least some of the values at the given position across the group of tiles, respectively, in a given stream, encodes the loaded values at the given position across the group of tiles, respectively (thereby producing encoded data for the loaded values at the given position across the group of tiles, respectively), and outputs the encoded data for the loaded values at the given position across the group of tiles, respectively.

In general, the encoding (420) the group of tiles proceeds in a direction that is, for the group of tiles, orthogonal to the multiple dimensions. The encoding (420) the group of tiles can use, for any given stream of tensor values, lossy compression and/or lossless compression (entropy coding) as described with reference to FIG. 2. The encoding (420) the group of tiles can use multiple encoders (implemented, e.g., with different processing cores or different instances of encoder logic), where each of the encoders is configured to accept, as constant-rate input, values at one of the positions of the tile size and to produce, as variable-rate output, encoded data for the one of the positions of the tile size.

The encoding (420) the group of tiles can be performed in parallel for at least some of the positions of the tile size. In FIG. 4b, compression operations are performed in parallel for different streams of tensor values. For position 1 of the respective tiles in the group of tiles, the matrix processing tool loads (431) values at position 1 across the group of tiles in stream 1 and encodes (441) the values at position 1 across the group of tiles, which produces encoded data for the values at position 1 across the group of tiles. The matrix processing tool outputs (451) the encoded data for the values at position 1 across the group of tiles. Concurrently, the matrix processing tool performs operations for other streams of tensor values. In FIG. 4b, the matrix processing tool loads (43n) values at position n across the group of tiles in stream n and encodes (44n) the values at position n across the group of tiles, which produces encoded data for the values at position n across the group of tiles. The matrix processing tool outputs (45n) the encoded data for the values at position n across the group of tiles. In this way, when the count of the positions of the tile size is less than or equal to the count of available processing cores for the encoding (420) the group of tiles, the encoding (420) can be performed in parallel for all of the positions of the tile size, such that that the tensor values of the group of tiles are encoded on a tile-by-tile basis.

Alternatively, compression operations can be performed serially (not in parallel) for at least some of the different streams of tensor values. In this case, when the count of the positions of the tile size is greater than the count of available processing cores for the encoding (420) the group of tiles, but there are still at least two available processing cores, the encoding (420) can still be performed in parallel for a subset of the positions of the tile size.

For the encoding (420) the group of tiles, the tiles are ordered according to a layout for the tiles. In some implementations, the matrix processing tool uses a tile blocking algorithm to determine the layout for the tiles, and the layout indicates the tile size, the locations of the tiles within the tensor, and the tile order for compression and decompression. The layout can be determined by the tile blocking algorithm depending on the size of the tensor, an expected utilization pattern of tensor blocks overlapping the tiles (e.g., loading tensor blocks that include the tiles in a horizontal direction or vertical direction; loading tensor blocks that include the tiles along an internal matrix dimension common to two input tensor or along an outer matrix dimension), and/or hardware capabilities of processing cores of the computer system (e.g., a count of available processing cores for compression). The tile blocking algorithm can also consider other factors (e.g., size of tiles that avoids use of padded values, given a tensor size; overall count of tiles/tensor blocks that tends to result in full utilization of tensor cores in waves, not partial utilization of less than all tensor cores in a final wave). The matrix processing tool can output information indicating the layout of the tiles (tile size, locations of tiles in the tensor, order for compression and decompression). Alternatively, to the extent such information can be derived as needed from other information (e.g., size of the tensor; configuration of processing cores), the matrix processing tool can skip outputting the information indicating the layout of the tiles.

In some configurations, the group of tiles that is encoded includes all of the tiles of the tensor. Alternatively, the group of tiles that is encoded includes a subset of at least two of the tiles of the tensor (not all of the tiles). In this case, when the matrix processing tool encodes (420) the group of tiles, the matrix processing tool selects one of multiple random-access-point tiles among the tiles of the tensor and starts encoding the values of the selected random-access-point tile without dependency on any value of another tile among the tiles of the tensor. The matrix processing tool can encode other groups of tiles starting at other random-access-point tiles for those groups, respectively. During compression, to trade off speed of access and compression efficiency, the matrix processing tool can set a frequency of random-access-point tiles (e.g., a new group of tiles every x tiles, where x is 128, 256, 512, or some other value).

With reference to FIG. 5a, a matrix processing tool receives (510) encoded data for values of a tensor. The values of the tensor are logically organized along multiple dimensions. The tensor has been split into tiles having a tile size with multiple positions. Each of the tiles includes a different subset of the values of the tensor.

The matrix processing tool decodes (520) a group of tiles (among the multiple tiles of the tensor) as multiple streams. Different positions (among the multiple positions) of the tile size are associated with different streams (among the multiple streams for the group of tiles of the tensor). As part of the decoding (520) the group of tiles, the matrix processing tool performs operations for each of the different positions of the tile size. For example, for each given position, the matrix processing tool loads encoded data for at least some of the values at the given position across the group of tiles, respectively, decodes the encoded data for the at least some of the values at the given position across the group of tiles, respectively (thereby producing the at least some of the values at the given position across the group of tiles, respectively, in a given stream), and outputs the at least some of the values at the given position across the group of tiles, respectively, in the given stream.

In general, the decoding (520) the group of tiles proceeds in a direction that is, for the group of tiles, orthogonal to the multiple dimensions. The decoding (520) the group of tiles can use, for any given stream of tensor values, lossy decompression and/or lossless decompression (entropy decoding) as described with reference to FIG. 3. The decoding (520) the group of tiles can use multiple decoders (implemented, e.g., with different processing cores or different decoder logic), where each of the decoders is configured to accept, as variable-rate input, encoded data for one of the positions of the tile size and to produce, as constant-rate output, values at the one of the positions of the tile size.

The decoding (520) the group of tiles can be performed in parallel for at least some of the positions of the tile size. In FIG. 5b, decompression operations are performed in parallel for different streams of tensor values. For position 1 of the respective tiles in the group of tiles, the matrix processing tool loads (531) encoded data for values at position 1 across the group of tiles and decodes (541) the encoded data for the values at position 1 across the group of tiles, which produces the values at position 1 across the group of tiles in stream 1. The matrix processing tool outputs (551) the values at position 1 across the group of tiles in stream 1. Concurrently, the matrix processing tool performs operations for other streams of tensor values. In FIG. 5b, the matrix processing tool loads (53n) encoded data for values at position n across the group of tiles and decodes (54n) the encoded data for the values at position n across the group of tiles, which produces the values at position n across the group of tiles in stream n. The matrix processing tool outputs (55n) the values at position n across the group of tiles in stream n. In this way, when the count of the positions of the tile size is less than or equal to the count of available processing cores for the decoding (520) the group of tiles, the decoding (520) can be performed in parallel for all of the positions of the tile size, such that the tensor values of the group of tiles are decoded on a tile-by-tile basis.

Alternatively, decompression operations can be performed serially (not in parallel) for at least some of the different streams of tensor values. In this case, when the count of the positions of the tile size is greater than the count of available processing cores for the decoding (520) the group of tiles but there are still at least two available processing cores, the decoding (520) can still be performed in parallel for a subset of the positions of the tile size.

For the decoding (520) the group of tiles, the tiles have been ordered according to a layout for the tiles. In some implementations, the layout indicates the tile size, the locations of the tiles within the tensor, and the tile order for compression and decompression. The matrix processing tool can use the layout to determine locations of tiles in the tensor. The matrix processing tool can receive information indicating the layout for the tiles. Or, the layout for decompression operations can be independently derived by the matrix processing tool using a tile blocking algorithm, as described with reference to FIG. 4.

In some configurations, the group of tiles that is decoded includes all of the tiles of the tensor. Alternatively, the group of tiles that is decoded includes a subset of at least two of the tiles of the tensor (not all of the tiles). In this case, when the matrix processing tool decodes (520) the group of tiles, the matrix processing tool identifies one of multiple random-access-point tiles among the tiles of the tensor and starts decoding the values of the identified random-access-point tile without any dependency on any value of another tile among the multiple tiles.

The matrix processing tool can populate the tensor with the decoded values of the group of tiles. The matrix processing tool can then load one or more tensor blocks to local memory of one or more tensor cores, where each of the tensor block(s) includes one or more of the tiles of the decoded group of tiles. A tensor core can have its own local memory or share its local memory with one or more other tensor cores. If the tile size of the tiles is equal to the size of tensor blocks for the tensor cores, each tensor block can include the tensor values from a single decoded tile. Alternatively, if the tile size of the tiles is not equal to the size of the tensor blocks for the tensor cores, each tensor block can include tensor values from part of one tile or from multiple tiles. In this way, each of the tensor block(s) can be loaded to local memory of an available one of the tensor cores when the tensor values of tile(s) in the tensor block have been decoded. In many cases, the decoding (520) the group of tiles can be performed with latency sufficiently low to avoid bottlenecks in the loading of tensor blocks to local memory of available ones of the tensor cores.

The following table shows some of the innovative features described herein for enabling parallelism in encoding or decoding of tensor values.

| | Feature |
|---|---|
| A1 | In a computer system, a method comprising: |
| | receiving values of a tensor, the values of the tensor being |
| | logically organized along multiple dimensions, the tensor |
| | being split into multiple tiles having a tile size with |
| | multiple positions, each of the multiple tiles including |
| | a different subset of the values of the tensor; and |
| | encoding a group of tiles among the multiple tiles as multiple |
| | streams, wherein different positions among the multiple |
| | positions of the tile size are associated with different |
| | streams among the multiple streams, and wherein the encoding |
| | the group of tiles includes, for each given position among |
| | the multiple positions of the tile size: |
| | loading at least some of the values at the given position |
| | across the group of tiles, respectively, in a given stream |
| | among the multiple streams; encoding the at least some of |
| | the values at the given position across the group of tiles, |
| | respectively, thereby producing encoded data for the at |
| | least some of the values at the given position across the |
| | group of tiles, respectively; and outputting the encoded |
| | data for the at least some of the values at the given |
| | position across the group of tiles, respectively. |
| A2 | The method of A1, wherein the encoding the group of tiles |
| | proceeds in a direction that is, for the group of tiles, |
| | orthogonal to the multiple dimensions. |
| A3 | The method of A1, wherein the encoding the group of tiles uses |
| | multiple encoders, each of the multiple encoders being |
| | implemented using a different processing core or different |
| | instance of encoder logic, and each of the multiple encoders |
| | being configured to accept, as constant-rate input, values |
| | at one of the multiple positions of the tile size and to |
| | produce, as variable-rate output, encoded data for the |
| | one of the multiple positions of the tile size. |
| A4 | The method of any one of A1 to A3, wherein the encoding the |
| | group of tiles includes, as part of lossless compression, |
| | one of context-adaptive binary arithmetic coding, another |
| | variant of arithmetic coding, range coding, Huffman coding, |
| | another variant of variable length coding, asymmetric numeral |
| | system coding, Lempel Ziv Welch encoding, and another |
| | variant of Lempel Ziv encoding. |
| A5 | The method of A4, wherein the encoding the group of tiles |
| | further includes, as part of lossy compression, quantization. |
| A6 | The method of any one of A1 to A5, wherein the encoding the |
| | group of tiles is performed in parallel for at least some of |
| | the multiple positions of the tile size. |
| A7 | The method of A6, wherein the encoding the group of tiles is |
| | performed in parallel for a subset of the multiple positions |
| | of the tile size, a count of the multiple positions of the |
| | tile size being greater than a count of available processing |
| | cores for the encoding the group of tiles. |
| A8 | The method of A6, wherein the encoding the group of tiles is |
| | performed in parallel for all of the multiple positions of |
| | the tile size, a count of the multiple positions of the tile |
| | size being less than or equal to a count of available processing |
| | cores for the encoding the group of tiles, such that the values |
| | of the group of tiles are encoded on a tile-by-tile basis. |
| A9 | The method of any one of A1 to A8, further comprising: |
| | ordering the group of tiles, for the encoding the group of tiles, |
| | according to a layout for the multiple tiles. |
| A10 | The method of A9, further comprising: |
| | using a tile blocking algorithm to determine the layout for the |
| | multiple tiles, the layout indicating the tile size, locations |
| | of the multiple tiles within the tensor, and tile order for |
| | compression and decompression, wherein the layout determined by |
| | the tile blocking algorithm depends on size of the tensor, an |
| | expected utilization pattern of tensor blocks overlapping the |
| | multiple tiles, and/or hardware capabilities of processing |
| | cores of the computer system. |
| A11 | The method of A9 or A10, further comprising: |
| | outputting information indicating the layout for the multiple |
| | tiles. |
| A12 | The method of any one of A1 to A11, further comprising: |
| | padding the tensor, or one or more of the multiple tiles, with |
| | zero values so that the tensor includes an integer count of |
| | tiles in each of the multiple dimensions. |
| A13 | The method of any one of A1 to A12, wherein the group of tiles |
| | includes all of the multiple tiles. |
| A14 | The method of any one of A1 to A12, wherein the group of tiles |
| | includes a subset of at least two of the multiple tiles, and |
| | wherein the encoding the group of tiles includes: |
| | selecting one of multiple random-access-point tiles among the |
| | multiple tiles; and starting encoding of values of the selected |
| | random-access-point tile without dependency on any value of |
| | another tile among the multiple tiles. |
| A15 | The method of A14, further comprising: |
| | setting a frequency of random-access-point tiles to trade off |
| | speed of access and compression efficiency. |
| B1 | In a computer system, a method comprising: |
| | receiving encoded data for values of a tensor, the values of the |
| | tensor being logically organized along multiple dimensions, the |
| | tensor being split into multiple tiles having a tile size with |
| | multiple positions, each of the multiple tiles including a |
| | different subset of the values of the tensor; and decoding |
| | a group of tiles among the multiple tiles as multiple streams, |
| | wherein different positions among the multiple positions of |
| | the tile size are associated with different streams among the |
| | multiple streams, and wherein the decoding the group of tiles |
| | includes, for each given position among the multiple |
| | positions of the tile size: |
| | loading encoded data for at least some of the values at the given |
| | position across the group of tiles, respectively; decoding the |
| | encoded data for the at least some of the values at the given |
| | position across the group of tiles, respectively, thereby |
| | producing the at least some of the values at the given position |
| | across the group of tiles, respectively, in a given stream |
| | among the multiple streams; and outputting the at least some |
| | of the values at the given position across the group of tiles, |
| | respectively, in the given stream. |
| B2 | The method of B1, wherein the decoding the group of tiles |
| | proceeds in a direction that is, for the group of tiles, |
| | orthogonal to the multiple dimensions. |
| B3 | The method of B1, wherein the decoding the group of tiles uses |
| | multiple decoders, each of the multiple decoders being |
| | implemented using a different processing core or different |
| | instance of decoder logic, and each of the multiple decoders |
| | being configured to accept, as variable-rate input, encoded |
| | data for one of the multiple positions of the tile size and |
| | to produce, as constant-rate output, values at the one of |
| | the multiple positions of the tile size. |
| B4 | The method of any one of B1 to B3, wherein the decoding the |
| | group of tiles includes, as part of lossless decompression, |
| | entropy decoding that reverses one of context-adaptive binary |
| | arithmetic coding, another variant of arithmetic coding, |
| | range coding, Huffman coding, another variant of variable length |
| | coding, asymmetric numeral system coding, Lempel Ziv Welch |
| | encoding, and another variant of Lempel Ziv encoding. |
| B5 | The method of B4, wherein the decoding the group of tiles further |
| | includes, as part of lossy decompression, inverse quantization. |
| B6 | The method of any one of B1 to B5, wherein the decoding the |
| | group of tiles is performed in parallel for at least some of |
| | the multiple positions of the tile size. |
| B7 | The method of B6, wherein the decoding the group of tiles is |
| | performed in parallel for a subset of the multiple positions |
| | of the tile size, a count of the multiple positions of the |
| | tile size being greater than a count of available processing |
| | cores for the decoding the group of tiles. |
| B8 | The method of B6, wherein the decoding the multiple tiles is |
| | performed in parallel for all of the multiple positions of |
| | the tile size, a count of the multiple positions of the tile |
| | size being less than or equal to a count of available processing |
| | cores for the decoding the group of tiles, such that the values |
| | of the group of tiles are decoded on a tile-by-tile basis. |
| B9 | The method of any one of B1 to B8, wherein the group of tiles |
| | have been ordered, for encoding, according to a layout for the |
| | multiple tiles, the layout indicating the tile size, locations |
| | of the multiple tiles within the tensor, and tile order for |
| | compression and decompression, the method further comprising: |
| | using the layout to determine location of a tile of the group |
| | of tiles in the tensor. |
| B10 | The method of B9, further comprising: |
| | using a tile blocking algorithm to determine the layout for |
| | the multiple tiles, wherein the layout determined by the |
| | tile blocking algorithm depends on size of the tensor, an |
| | expected utilization pattern of tensor blocks overlapping |
| | the multiple tiles, and/or hardware capabilities of |
| | processing cores of the computer system. |
| B11 | The method of B9 or B10, further comprising: |
| | receiving information indicating the layout for the multiple |
| | tiles. |
| B12 | The method of any one of B1 to B11, further comprising: |
| | removing zero values added to the tensor, or one or more of |
| | the multiple tiles, for padding so that the tensor includes |
| | an integer count of tiles in each of the multiple dimensions. |
| B13 | The method of any one of B1 to B12, wherein the decoding the |
| | group of tiles includes all of the multiple tiles. |
| B14 | The method of any one of B1 to B12, wherein the group of tiles |
| | includes a subset of at least two of the multiple tiles, |
| | and wherein the decoding the group of tiles includes: |
| | identifying one of multiple random-access-point tiles among |
| | the multiple tiles; and starting decoding of values of the |
| | identified random-access-point tile without dependency on |
| | any value of another tile among the multiple tiles. |
| B15 | The method of any one of B1 to B14, further comprising: |
| | populating the tensor with the decoded group of tiles; and |
| | loading one or more tensor blocks to local memory of one or more |
| | tensor cores, wherein each of the one or more tensor blocks |
| | includes at least part of one or more of the tiles of the |
| | decoded group of tiles. |
| B16 | The method of B15, wherein the decoding the group of tiles is |
| | performed with latency sufficiently low to avoid bottlenecks |
| | in the loading of the one or more tensor blocks to local |
| | memory of available ones of the tensor cores. |
| AB1 | The method of any one of A1 to A15 and B1 to B15, wherein: |
| | size of the tensor is [W, H], W being the width of |
| | the tensor, and H being the height of the tensor; and size |
| | of the tiles is [w, h], w being the width of each of |
| | the multiple tiles, and h being the height of each of |
| | the multiple tiles, and wherein w is less than W, and h |
| | is less than H. |
| AB2 | The method of any one of A1 to A15 and B1 to B15, wherein: |
| | the values of the tensor are logically organized along two |
| | dimensions, and, for each of the multiple tiles, the |
| | subset of the values of the tensor are logically organized |
| | along the two dimensions; the values of the tensor are |
| | logically organized along three dimensions, and, for |
| | each of the multiple tiles, the subset of the values of the |
| | tensor are logically organized along the three dimensions; |
| | and the values of the tensor are logically organized along |
| | four dimensions, and, for each of the multiple tiles, the |
| | subset of the values of the tensor are logically organized |
| | along the four dimensions. |
| AB3 | The method of any one of A1 to A15, B1 to B15, AB1, and AB2, |
| | wherein the values of the tensor are: |
| | weights of edges between nodes of two layers of a neural network; |
| | bias values for nodes of a layer of the neural network; or |
| | results from activation functions at nodes of a layer of the |
| | neural network. |
| AB4 | The method of any one of A1 to A15, B1 to B15, AB1, and AB2, |
| | wherein the values of the tensor are: |
| | floating point values, each of the floating point values |
| | including a mantissa value and an exponent value; or |
| | integer values. |
| AB5 | The method of any one of A1 to A15, B1 to B15, and AB1 to |
| | AB4, wherein: for the tensor, each of the multiple dimensions |
| | is over 100 values, over 1,000 values, or over 10,000 values; |
| | and for the tile size, each of the multiple dimensions |
| | is a multiple of 4. |
| AB6 | The method of any one of A1 to A15, B1 to B15, and AB1 to |
| | AB5, wherein the method is performed during training |
| | operations for a machine learning model. |
| AB7 | The method of any one of A1 to A15, B1 to B15, and AB1 to |
| | AB5, wherein the method is performed during inference |
| | operations for a machine learning model. |
| AB8 | One or more computer-readable media having stored thereon |
| | computer-executable instructions for causing a processor |
| | system, when programmed thereby, to perform operations |
| | of any one of A1 to A15, B1 to B15, and AB1 to AB7. |
| AB9 | One or more computer-readable media having stored thereon |
| | the encoded data produced by the method of any one of |
| | claims A1 to A14 and AB1 to AB7. |
| AB10 | One or more computer-readable media having stored thereon the |
| | encoded data, wherein the encoded data is organized to |
| | facilitate decoding with operations of any one of claims B1 |
| | to B15 and AB1 to AB7. |
| AB11 | A computer system comprising multiple processing cores, |
| | multiple tensor cores, and memory, the computer system |
| | being configured to perform operations of any one of |
| | A1 to A14, B1 to B15, and AB1 to AB7. |

### VII. Example Computer Systems

FIG. 7 illustrates a generalized example of a suitable computer system (700) in which several of the described innovations may be implemented. The innovations described herein relate to parallel variable-rate compression and decompression of values of a tensor. The computer system (700) is not intended to suggest any limitation as to scope of use or functionality, as the innovations may be implemented in diverse computer systems, including special-purpose computer systems.

With reference to FIG. 7, the computer system (700) includes one or more processing cores (711 . . . 71x) and local memory (718) of a central processing unit (“CPU”) (710) or multiple CPUs. The processing core(s) (711 . . . 71x) are, for example, processing cores on a single chip, and execute computer-executable instructions. The number of processing core(s) (711 . . . 71x) depends on implementation and can be, for example, 4 or 8. The local memory (718) may be volatile memory (e.g., registers, cache, random access memory (“RAM”)), non-volatile memory (e.g., read-only memory (“ROM”), electrically erasable programmable ROM (“EEPROM”), flash memory), or some combination of the two, accessible by the respective processing core(s) (711 . . . 71x). Alternatively, the processing cores (711 . . . 71x) can be part of a system-on-a-chip (“SoC”), application-specific integrated circuit (“ASIC”), or other integrated circuit.

The local memory (718) can store software (780) implementing aspects of the innovations for parallel variable-rate compression and decompression of values of a tensor, for operations performed by the respective processing core(s) (711 . . . 71x), in the form of computer-executable instructions. In FIG. 7, the local memory (718) is on-chip memory such as one or more caches, for which access operations, transfer operations, etc. with the processing core(s) (711 . . . 71x) are fast. The local memory (718) of one of the processing cores (711 . . . 71x) may be specific to that processing core or shared with other ones of the processing cores (711 . . . 71x).

The computer system (700) also includes processing cores (731 . . . 73x) and local memory (738) of a graphics processing unit (“GPU”) or neural processing unit (“NPU”) (730), or multiple GPUs or NPUs. The number of processing cores (731 . . . 73x) of the GPU or NPU depends on implementation. For a GPU, the processing cores (731 . . . 73x) are, for example, part of single-instruction, multiple data (“SIMD”) units of the GPU. The SIMD width n, which depends on implementation, indicates the number of elements (sometimes called lanes) of a SIMD unit. For an NPU, the processing cores (731 . . . 73x) include, for example, tensor cores (specialized hardware blocks) for operations such as matrix multiplication and convolution. The local memory (738) may be volatile memory (e.g., registers, cache, RAM), non-volatile memory (e.g., ROM, EEPROM, flash memory), or some combination of the two, accessible by the respective processing cores (731 . . . 73x). The local memory (738) of one of the processing cores (731 . . . 73x) may be specific to that processing core or shared with other ones of the processing cores (731 . . . 73x). The memory (738) can store software (780) implementing aspects of the innovations for parallel variable-rate compression and decompression of values of a tensor, for operations performed by the respective processing cores (731 . . . 73x), in the form of computer-executable instructions such as shader code (for a GPU) or specialized code for machine learning hardware blocks (for an NPU).

As used herein, the term “tensor core” indicates a hardware block dedicated to perform matrix multiplication and accumulation operations at higher speed and/or better precision, compared to another type of processing core. For example, a tensor core can be a specialized hardware block in an NPU or GPU. A tensor core can be adapted to perform matrix multiplication and accumulation operations. Alternatively, a tensor core can simply be reserved for such operations or can prioritize performance of such operations. Otherwise, the term “processing core” indicates a type of processing core, e.g., in a CPU, GPU, or NPU, that is not dedicated to perform matrix multiplication and accumulation operations at higher speed and/or better precision, compared to a tensor core. In particular, such a processing core can perform encoding or decoding of tensor values for tiles to be loaded into local memory of a tensor core. The local memory of a tensor core may be specific to that tensor core or shared with one or more other tensor cores.

The computer system (700) includes main memory (720), which may be volatile memory (e.g., RAM), non-volatile memory (e.g., ROM, EEPROM, flash memory), or some combination of the two, accessible by the processing core(s) (711 . . . 71x, 731 . . . 73x). The main memory (720) stores software (780) implementing aspects of the innovations for parallel variable-rate compression and decompression of values of a tensor, in the form of computer-executable instructions. In FIG. 7, the main memory (720) is off-chip memory (system memory), for which access operations, transfer operations, etc. with the processing cores (711 . . . 71x, 731 . . . 73x) are slower.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, GPU, or NPU. A processor may also be a specific-purpose processor implemented using, for example, an ASIC or a field-programmable gate array (“FPGA”). A “processor system” is a set of one or more processors, which can be located together or distributed across a network.

The term “control logic” refers to a controller or, more generally, one or more processors, operable to process computer-executable instructions, determine outcomes, and generate outputs. Depending on implementation, control logic can be implemented by software executable on a CPU, by software controlling special-purpose hardware (e.g., a GPU, other graphics hardware, or an NPU), or by special-purpose hardware (e.g., in an ASIC).

The computer system (700) includes one or more network interface devices (740). The network interface device(s) (740) enable communication over a network to another computing entity (e.g., server, other computer system). The network interface device(s) (740) can support wired connections and/or wireless connections, for a wide-area network, local-area network, personal-area network, or other network. For example, the network interface device(s) can include one or more Wi-Fi® transceivers, an Ethernet® port, a cellular transceiver and/or another type of network interface device, along with associated drivers, software, etc. The network interface device(s) (740) convey information such as computer-executable instructions, audio or video input or output, or other data in a modulated data signal over network connection(s). A modulated data signal is a signal that has one or more of its characteristics set or changed in such a manner as to encode information in the signal. By way of example, the network connections can use an electrical, optical, RF, or other carrier.

The computer system (700) optionally includes a motion sensor/tracker input (742) for a motion sensor/tracker, which can track the movements of a user and objects around the user. For example, the motion sensor/tracker allows a user (e.g., player of a game) to interact with the computer system (700) through a natural user interface using gestures and spoken commands. The motion sensor/tracker can incorporate gesture recognition, facial recognition and/or voice recognition.

The computer system (700) optionally includes a game controller input (744), which accepts control signals from one or more game controllers, over a wired connection or wireless connection. The control signals can indicate user inputs from one or more directional pads, buttons, triggers and/or one or more joysticks of a game controller. The control signals can also indicate user inputs from a touchpad or touchscreen, gyroscope, accelerometer, angular rate sensor, magnetometer and/or other control or meter of a game controller.

The computer system (700) optionally includes a media player (746) and video source (748). The media player (746) can play DVDs, Blu-ray™ discs, other disc media and/or other formats of media. The video source (748) can be a camera input that accepts video input in analog or digital form from a video camera, which captures natural video. Alternatively, the video source (748) can be a screen capture module (e.g., a driver of an operating system, or software that interfaces with an operating system) that provides screen capture content as input. Or, as another alternative, the video source (748) can be a graphics engine that provides texture data for graphics in a computer-represented environment. Or, as another alternative, the video source (748) can be a video card, TV tuner card, or other video input that accepts input video in analog or digital form (e.g., from a cable input, High-Definition Multimedia Interface (“HDMI”) input or other input).

An optional audio source (750) accepts audio input in analog or digital form from a microphone, which captures audio, or other audio input.

The computer system (700) optionally includes a video output (760), which provides video output to a display device. The video output (760) can be an HDMI output or other type of output. An optional audio output (760) provides audio output to one or more speakers.

The storage (770) may be removable or non-removable, and includes magnetic media (such as magnetic disks, magnetic tapes or cassettes), optical disk media and/or any other media which can be used to store information, and which can be accessed within the computer system (700). The storage (770) stores instructions for the software (780) implementing aspects of the innovations for parallel variable-rate compression and decompression of values of a tensor.

The computer system (700) may have additional features. For example, the computer system (700) includes one or more other input devices and/or one or more other output devices. The other input device(s) may be a touch input device such as a keyboard, mouse, pen, or trackball, a scanning device, or another device that provides input to the computer system (700). The other output device(s) may be a printer, CD-writer, or another device that provides output from the computer system (700).

An interconnection mechanism (not shown) such as a bus, controller, or network interconnects the components of the computer system (700). Typically, operating system software (not shown) provides an operating environment for other software executing in the computer system (700), and coordinates activities of the components of the computer system (700).

The computer system (700) of FIG. 7 is a physical computer system. A virtual machine can include components organized as shown in FIG. 7.

The term “application” or “program” refers to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including non-volatile media and volatile media. Non-volatile media include, for example, optical or magnetic disks and other persistent memory. Volatile media include dynamic random-access memory (“DRAM”). Common forms of computer-readable media include, for example, a solid-state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “non-transitory computer-readable media” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control a GPU, NPU, or special-purpose hardware to provide functionality described herein, instructions executable on processing cores of a GPU or NPU to provide functionality described herein, and/or instructions executable on processing cores of a special-purpose processor to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and a computer system can include any combination of special-purpose hardware and/or hardware with software implementing the functionality described herein.

Numerous examples are described in this disclosure and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular features of the disclosed innovations may be described with reference to one or more particular examples, it should be understood that such features are not limited to usage in the one or more particular examples with reference to which they are described, unless expressly specified otherwise. The present disclosure is neither a literal description of all examples nor a listing of features of the invention that must be present in all examples.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and a computer system can include any combination of special-purpose hardware and/or hardware with software implementing the functionality described herein.

The respective techniques and tools described herein may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and they may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

As used herein, the term “set,” when used as a noun to indicate a group of elements, indicates a non-empty group, unless context clearly indicates otherwise. That is, the “set” has one or more elements, unless context clearly indicates otherwise.

As used herein, the term “based on” or “based at least in part on” indicates a dependence. A value or output X that is “based on” (or “based at least in part on”) a value or input Y depends on Y but can also depend on additional information or factors. Y can be directly or indirectly used when determining, assigning, generating, calculating, or creating X “based on” (or “based at least in part on”) Y. Thus, for example, the language determining or assigning X “based on” Y can indicate determining or assigning X using Y.

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps or stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and these terms should not be confused with acts performed by a human being. The actual computer operations corresponding to these terms vary depending on implementation.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique or tool does not solve all such problems. It is to be understood that other examples may be utilized and that structural, logical, software, hardware, and electrical changes may be made without departing from the scope of the disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A computer system comprising multiple processing cores, multiple tensor cores, and memory, the computer system being configured to perform operations comprising:
receiving values of a tensor, the values of the tensor being logically organized along multiple dimensions, the tensor being split into multiple tiles having a tile size with multiple positions, each of the multiple tiles including a different subset of the values of the tensor; and
encoding a group of tiles among the multiple tiles as multiple streams, wherein different positions among the multiple positions of the tile size are associated with different streams among the multiple streams, and wherein the encoding the group of tiles includes, for each given position among the multiple positions of the tile size:
loading at least some of the values at the given position across the group of tiles, respectively, in a given stream among the multiple streams;
encoding the at least some of the values at the given position across the group of tiles, respectively, thereby producing encoded data for the at least some of the values at the given position across the group of tiles, respectively; and
outputting the encoded data for the at least some of the values at the given position across the group of tiles, respectively.

2. The computer system of claim 1, wherein the encoding the group of tiles uses multiple encoders, each of the multiple encoders being implemented using a different processing core or different instance of encoder logic, and each of the multiple encoders being configured to accept, as constant-rate input, values at one of the multiple positions of the tile size and to produce, as variable-rate output, encoded data for the one of the multiple positions of the tile size.

3. The computer system of claim 1, wherein the encoding the group of tiles is performed in parallel for at least some of the multiple positions of the tile size.

4. The computer system of claim 1, wherein the operations further comprise:
using a tile blocking algorithm to determine the layout for the multiple tiles, the layout indicating the tile size, locations of the multiple tiles within the tensor, and tile order for compression and decompression, wherein the layout determined by the tile blocking algorithm depends on size of the tensor, an expected utilization pattern of tensor blocks overlapping the multiple tiles, and/or hardware capabilities of processing cores of the computer system; and
ordering the group of tiles, for the encoding the group of tiles, according to the layout for the multiple tiles.

5. The computer system of claim 4, wherein the operations further comprise:
outputting information indicating the layout for the multiple tiles.

6. The computer system of claim 1, wherein the operations further comprise:
padding the tensor, or one or more of the multiple tiles, with zero values so that the tensor includes an integer count of tiles in each of the multiple dimensions.

7. The computer system of claim 1, wherein the group of tiles includes a subset of at least two of the multiple tiles, and wherein the encoding the group of tiles includes:
selecting one of multiple random-access-point tiles among the multiple tiles; and
starting encoding of values of the selected random-access-point tile without dependency on any value of another tile among the multiple tiles.

8. In a computer system, a method comprising:
receiving encoded data for values of a tensor, the values of the tensor being logically organized along multiple dimensions, the tensor being split into multiple tiles having a tile size with multiple positions, each of the multiple tiles including a different subset of the values of the tensor;
decoding a group of tiles among the multiple tiles as multiple streams, wherein different positions among the multiple positions of the tile size are associated with different streams among the multiple streams, and wherein the decoding the group of tiles includes, for each given position among the multiple positions of the tile size:
loading encoded data for at least some of the values at the given position across the group of tiles, respectively;
decoding the encoded data for the at least some of the values at the given position across the group of tiles, respectively, thereby producing the at least some of the values at the given position across the group of tiles, respectively, in a given stream among the multiple streams; and
outputting the at least some of the values at the given position across the group of tiles, respectively, in the given stream.

9. The method of claim 8, wherein the decoding the group of tiles uses multiple decoders, each of the multiple decoders being implemented using a different processing core or different instance of decoder logic, and each of the multiple decoders being configured to accept, as variable-rate input, encoded data for one of the multiple positions of the tile size and to produce, as constant-rate output, values at the one of the multiple positions of the tile size.

10. The method of claim 8, wherein the decoding the group of tiles includes:
as part of lossless decompression, entropy decoding that reverses one of context-adaptive binary arithmetic coding, another variant of arithmetic coding, range coding, Huffman coding, another variant of variable length coding, asymmetric numeral system coding, Lempel Ziv Welch encoding, and another variant of Lempel Ziv encoding; and/or
as part of lossy decompression, inverse quantization.

11. The method of claim 8, wherein the decoding the group of tiles is performed in parallel for a subset of the multiple positions of the tile size, a count of the multiple positions of the tile size being greater than a count of available processing cores for the decoding the group of tiles.

12. The method of claim 8, wherein the decoding the group of tiles is performed in parallel for all of the multiple positions of the tile size, a count of the multiple positions of the tile size being less than or equal to a count of available processing cores for the decoding the group of tiles, such that the values of the group of tiles are decoded on a tile-by-tile basis.

13. The method of claim 8, wherein the group of tiles have been ordered, for encoding, according to a layout for the multiple tiles, the layout indicating the tile size, locations of the multiple tiles within the tensor, and tile order for compression and decompression, the method further comprising:
using the layout to determine location of a tile of the group of tiles in the tensor.

14. The method of claim 13, further comprising:
receiving information indicating the layout for the multiple tiles.

15. The method of claim 8, wherein the group of tiles includes a subset of at least two of the multiple tiles, and wherein the decoding the group of tiles includes:
identifying one of multiple random-access-point tiles among the multiple tiles; and
starting decoding of values of the identified random-access-point tile without dependency on any value of another tile among the multiple tiles.

16. The method of claim 8, further comprising:
populating the tensor with the decoded group of tiles; and
loading one or more tensor blocks to local memory of one or more tensor cores, wherein each of the one or more tensor blocks includes at least part of one or more of the tiles of the decoded group of tiles.

17. The method of claim 8, wherein:
size of the tensor is [W, H], W being the width of the tensor, and H being the height of the tensor; and
size of the tiles is [w, h], w being the width of each of the multiple tiles, and h being the height of each of the multiple tiles, and wherein w is less than W, and h is less than H.

18. The method of claim 8, wherein the values of the tensor are:
weights of edges between nodes of two layers of a neural network;
results from activation functions at outputs from nodes of a layer of the neural network.

19. The method of claim 8, wherein the values of the tensor are:
floating point values, each of the floating point values including a mantissa value and an exponent value; or
integer values.

20. One or more computer-readable media having stored thereon encoded data for values of a tensor, the values of the tensor being logically organized along multiple dimensions, the tensor being split into multiple tiles having a tile size with multiple positions, each of the multiple tiles including a different subset of the values of the tensor, wherein the encoded data is organized to facilitate decoding a group of tiles among the multiple tiles as multiple streams, in a computer system, with operations, wherein different positions among the multiple positions of the tile size are associated with different streams among the multiple streams, and wherein the operations comprise, for each given position among the multiple positions of the tile size:
loading encoded data for at least some of the values at the given position across the group of tiles, respectively;
decoding the encoded data for the at least some of the values at the given position across the group of tiles, respectively, thereby producing the at least some of the values at the given position across the group of tiles, respectively, in a given stream among the multiple streams; and
outputting the at least some of the values at the given position across the group of tiles, respectively, in the given stream.
